(19) United States
(12) Patent Application Publication
(10) Pub. No.: US 2011/0088433 A1
(43) Pub. Date: Apr. 21, 2011

(54) Methods For Drawing Multimode Bend Resistant Optical Fiber

(76) Inventors: Allen Eugene Allegretto, Wilmington, NC (US); Scott Robertson Bickham, Corning, NY (US); Ian D. Cook, Wilmington, NC (US); Igor Rafaelyevich Mejouev, Wilmington, NC (US); Snigdharaj Kumar Mishra, Wilmington, NC (US); Kimberly Ann Wilbert, Wilmington, NC (US)

(21) Appl. No.: 12/579,891

(22) Filed: Oct. 15, 2009

(51) Int. Cl. G01N 23/00; G01N 21/00

(52) U.S. Cl. 65/378; 356/73.1

(57) ABSTRACT

According to one embodiment, a method for characterizing a multimode, bend resistant optical fiber may include determining a core refractive index profile for a core portion of a preform and determining a moat refractive index profile for a moat portion of the preform. Thereafter, a property of a multimode optical fiber is determined prior to drawing the multimode optical fiber from the preform. The property of the multimode fiber is determined based on the core refractive index profile of the preform, the moat refractive index profile of the preform, the inner radius rᵢₙ and the outer radius rₒᵤₜ of a depressed-index annular portion of the multimode optical fiber and fiber property coefficients.

### BACKGROUND

1. Field

The present specification generally relates to optical fibers and, more specifically, to methods for drawing multimode bend resistant optical fiber from preforms.

2. Technical Background

Glass optical fibers with high bandwidth and improved bend-loss properties have recently been of significant interest in the telecommunications field. High bandwidth multimode fibers have been designed to meet the ever increasing demand for optical fibers capable of high volume data transmission. Such optical fiber designs may also be optimized to improve the bend-loss properties of the optical fiber. These fiber designs facilitate the use of such high bandwidth, multimode optical fiber for fiber to the home and fiber to the desk (FTTD) applications where bending loss has previously limited many designs from practical use.

While current fiber designs facilitate high bandwidth multimode bend-loss resistant optical fibers, a need exists for alternative methods for characterizing such optical fiber before the optical fiber is drawn from a preform.

### SUMMARY

According to one embodiment, a method for characterizing a multimode, bend resistant optical fiber may include determining a core refractive index profile for a core portion of a preform and determining a moat refractive index profile for a moat portion of the preform. Thereafter, a property of a multimode optical fiber is determined prior to drawing the multimode optical fiber from the preform. The property of the multimode fiber is determined based on the core refractive index profile of the preform, the moat refractive index profile of the preform, an inner radius rᵢₙ and an outer radius rₒᵤₜ of a depressed-index annular portion of the multimode optical fiber and fiber property coefficients.

In another embodiment, a method of drawing a multimode optical fiber from a preform may include determining a core refractive index profile of a core portion of a preform and determining a moat refractive index profile of a moat portion of the preform. Thereafter, a bend-loss of a multimode optical fiber is determined prior to drawing the multimode optical fiber from the preform. The bend-loss of the multimode optical fiber is determined based on the core refractive index profile of the preform, the moat refractive index profile of the preform, the inner radius rᵢₙ and outer radius rₒᵤₜ of a depressed-index annular portion of the multimode optical fiber and bend-loss coefficients. The bend-loss is compared to a target bend-loss range and, if the property is within the target bend-loss range, the multimode optical fiber is drawn from the preform.

Additional features and advantages of the invention will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A depicts a cross section of an optical fiber preform according to one embodiment shown and described herein;

FIG. 1B depicts a radial refractive index profile of the fiber preform of FIG. 1A;

FIG. 2A depicts a cross section of preform according to one embodiment shown and described herein;

FIG. 2B depicts a radial refractive index profile of the preform of FIG. 3 according to another embodiment shown and described herein;

FIG. 3 is a graphical representation of the relationship between the profile volume of a depressed-index annular portion of an optical fiber and the bend-loss of the optical fiber; and

FIG. 4 is a graphical representation of the relationship between the profile volume of a depressed-index annular portion of an optical fiber and the numerical aperture of the optical fiber.

### DETAILED DESCRIPTION OF THE PREFERRED EMBODIMENTS

Various embodiments of the method for drawing an optical fiber will now be described with specific reference to the accompanying drawings. Whenever possible, the same reference numerals will be used throughout the drawings to refer to the same or like parts.

As used herein, the phrase “refractive index profile” is the relationship between refractive index or relative refractive index and the radius of the optical fiber or preform.

As used herein, the phrase “relative refractive index percent” or “relative refractive index” of a region i is defined as

Δᵢ%(r)=100−(nᵢ(r)²−n_{REF}²)/2nᵢ(r)²,

where nᵢ is the refractive index in region i at radius r, unless otherwise specified. The relative refractive index percent is measured at 850 nm unless otherwise specified. The reference index n_{REF} is the refractive index of pure silica glass at 850 nm unless otherwise specified.

As used herein, the relative refractive index is represented by Δᵢ% and its values are given in units of “%”, unless otherwise specified. In cases where the refractive index of a region is less than the reference index n_{REF}, the relative refractive index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative refractive index percent is positive and the region can be said to be raised or to have a positive index. An “updopant” is herein considered to be a dopant which has a propensity to raise the refractive index relative to pure undoped SiO₂. A “downdopant” is herein considered to be a dopant which has a propensity to lower the refractive index relative to pure undoped SiO₂. An updopant may be present in a region of an optical fiber or preform having a negative relative refractive index when accompanied by one or more other dopants which are not updopants. Likewise, one or more other dopants which are not updopants may be present in a region of an optical fiber or preform having a positive relative refractive index. A downdopant may be present in a region of an optical fiber or preform having a positive relative refractive index when accompanied by one or more other dopants which are not downdopants. Likewise, one or more other dopants which are not downdopants may be present in a region of an optical fiber or preform having a negative relative refractive index.

When measured (as opposed to calculated) macrobend performance of a fiber is determined according to FOTP-62 (IEC-60793-1-47) by wrapping 1 turn around either a 15 mm or 30 mm diameter mandrel (the “1×15 mm diameter macrobend loss” or the “1×30 mm diameter macrobend loss”) and measuring the increase in attenuation due to the bending using an encircled flux launch (EFL) condition. The encircled flux was obtained by launching an overfilled pulse into an input end of a 2 m length of InfinicCor® 50 micron optical fiber which was deployed with a 1×25 mm diameter near the midpoint. The output end of the InfiniCor® 50 micron optical fiber was spliced to the fiber under test, and the measured bend loss was the ratio of the attenuation under the prescribed bend condition to the attenuation without the bend. For a fiber with low macrobend loss, the measurement is done by wrapping multiple turns on a mandrel to increase the accuracy. The macrobend loss was then normalized to 1 turn by dividing the total loss by the number of wraps around the mandrel.

When measured (as opposed to calculated), the numerical aperture of an optical fiber was measured using the method set forth in TIA SP3-2839-URV FOTP-177 IEC-60793-1-43 entitled “Measurement Methods and Test Procedures-Numerical Aperture.”

In the embodiments described herein, the refractive index profile of the preforms may be determined using the methodologies disclosed in U.S. patent application Ser. No. 12/414,188 filed Mar. 30, 2009 and entitled “METHODS OF MEASURING THE REFRACTIVE INDEX PROFILE OF A TRANSPARENT CYLINDRICAL OBJECT”, which is herein incorporated by reference.

The terms “α-profile” or “alpha profile” refer to a relative refractive index profile, expressed in terms of Δ %(r) which is in units of “%”, where r is the radius of the fiber and:

Δ %(r)=Δ(r₀)%(1−[|r−r₀|/(r₁−r₀)[^{α}),

where r₀ is the point at which Δ %(r) is a maximum, r₁ is the point at which Δ (r)% is zero, and r is in the range rᵢ≦r≦r_{f}, where Δ % is defined above, rᵢ is the initial point of the α-profile, r_{f} is the final point of the α-profile, and α is an exponent which is a real number. For multimode optical fiber, r₀=0 such that the above referenced equation becomes:

Δ %(r)=Δ(r₀)%(1−[|r|/(r₁)]^{α}).

In the embodiments described herein, the multimode fibers comprise a depressed-index annular portion disposed around the core. The depressed-index annular portion has a profile volume V defined herein as:

$$V = 2 {\int }_{{r}_{in}}^{{r}_{out}} {Δ}_{M} \% ( r ) \cdot r \cdot d r ,$$

where rᵢₙ is the inner radius of the depressed-index annular portion and rₒᵤₜ is the outer radius of the depressed-index annular portion where the radial thickness of the depressed-index annular portion is rₜₕ=rₒᵤₜ−rᵢₙ, as defined below. In the case where the refractive index of the moat has a constant value Δ_{M0}, the moat volume is

V=Δ_{M0}(rₒᵤₜ²rᵢₙ²).

The units for moat volume are Δ %-μm².

Methods of drawing a multimode, bend-loss resistant optical fiber will now be described in more detail with specific reference to the appended figures. The method generally includes characterizing an optical fiber preform prior to drawing optical fiber from the preform to verify that optical fiber drawn from the preform will have the desired bend-loss and/or numerical aperture properties. If it is determined that optical fiber drawn from the preform will have the desired bend-loss and/or numerical aperture properties, the optical fiber manufacturing process proceeds and optical fiber is drawn from the preform. However, if it is determined that optical fiber drawn from the preform will not have the desired bend-loss and/or numerical aperture properties, the preform is discarded and another preform is selected for characterization.

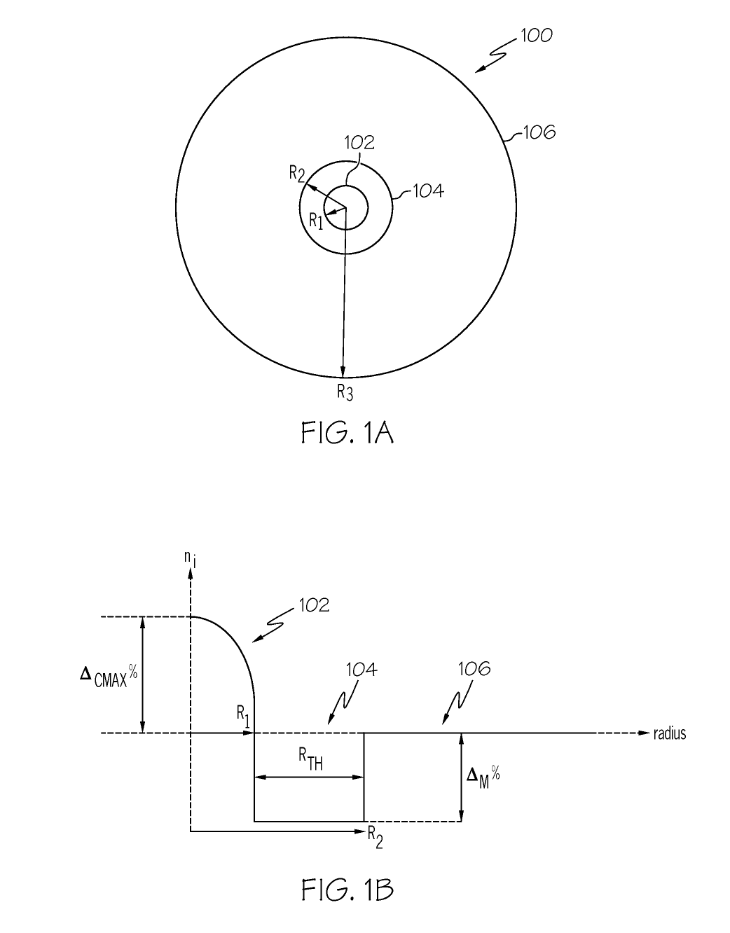

The method for drawing multimode, bend-loss resistant optical fiber begins with selecting an optical fiber preform which has the proper cross sectional area to facilitate a multimode, bend-loss resistant optical fiber. For example, referring to FIGS. 1A and 1B, a cross section of one embodiment of preform 100 which may be used to form multimode, bend-loss resistant optical fiber and the corresponding refractive index profile of the preform are depicted. The preform 100 may be drawn into optical fiber having reduced cross sectional dimensions with the same general cross sectional structure. The preform 100 generally comprises a glass portion comprising a core portion 102, a moat portion 104 and an outer glass cladding portion 106 which generally comprise silica, specifically silica-based glass. The cross section of the preform 100 may be generally circular-symmetric with respect to the center of the core portion 102. In the embodiment shown in FIG. 1A, the moat portion 104 surrounds and is in direct contact with the core portion 102. The core portion 102 may have a radius R₁. The moat portion 104 may surround the core portion 102 and extend from the radius R₁ to a radius R₂ such that the moat portion has a radial thickness R_{TH}=R₂−R₁. An outer glass cladding portion 106 may surround the moat portion 104 and extend from the radius R₂ to a radius R₃. Accordingly, in this embodiment, the glass portion of the optical fiber (e.g., the core portion 102, the moat portion 104 and outer glass cladding portion 106) may have an outer diameter 2R₃.

The core portion 102 may have an index of refraction n_{c} and a corresponding relative refractive index Δ_{c}% relative to pure silica glass and the moat portion 104 may have an index of refraction n_{M} and a corresponding relative refractive index Δ_{M}% relative to pure silica glass such that n_{C}>n_{M} and Δ_{C}%>Δ_{M}% as is graphically depicted in FIG. 1B.

In the embodiments shown and described herein, the core portion 102 of the preform has a graded index. For example, the refractive index profile of the core portion 102 has a parabolic or substantially parabolic shape. For example, in some embodiments, the refractive index profile of the core portion has an alpha-shape with a value of about 2, preferably between 1.8 and 2.3, as measured at 850 nm In some embodiments, the refractive index of the core portion may have a centerline dip wherein the maximum refractive index of the core portion, and the maximum refractive index of the entire preform, is located a small distance away from the center of the core portion of the preform. In other embodiments the refractive index of the core portion has no centerline dip, and the maximum refractive index of the core portion, and the maximum refractive index of the entire preform, is located at the center of the core portion of the preform. The parabolic shape extends to the radius R₁ and preferably extends from the center of the core portion 102 to R₁. As used herein, “parabolic” includes substantially parabolically shaped refractive index profiles which may vary slightly from an alpha value of 2.00 at one or more points in the core portion, as well as profiles with minor variations and/or a centerline dip.

The outer glass cladding portion 106 of the preform 100 may comprise an index of refraction n_{OC} and a relative refractive index Δ_{OC}% relative to pure silica glass which is generally greater than the relative refractive index Δ_{M}% of the moat portion 104 (e.g., Δ_{OC}%>Δ_{M}%) such that the moat portion 104 is a depressed index trench disposed between the core portion 102 and the outer glass cladding portion 106.

In the embodiments shown and described herein, the core portion 102 may comprise silica glass (SiO₂) comprising one or more index of refraction raising dopants such as, for example, GeO₂, Al₂O₃, P₂O₅, TiO₂, ZrO₂, Nb₂O₅ and/or Ta₂O₅, such as when the core portion 102 is “up-doped.” The core portion 102 may be up-doped with one or more index of refraction increasing dopants such that Δ_{C}% of the core portion 102 may be from about 0.2% to about 2%.

In some embodiments, the moat portion 104 comprises silica glass doped with fluorine. In some other embodiments, the moat portion 104 comprises silica comprising a plurality of non-periodically disposed voids. The voids may contain one or more gases, such as argon, nitrogen, krypton, CO₂, SO₂, or oxygen, or the voids may contain a vacuum with substantially no gas; regardless of the presence or absence of any gas, the refractive index in the moat portion 104 is lowered due to the presence of the voids. The voids can be randomly or non-periodically disposed in the moat portion 104, and in other embodiments, the voids are disposed periodically in the moat portion 104. Alternatively, or in addition, the moat portion 104 can also be provided by downdoping the moat portion 104 (such as with fluorine) or updoping one or more portions of the outer glass cladding portion and/or the core portion. Preferably, the minimum relative refractive index A_{M}% of the moat portion 104, taking into account the presence of any voids, is less than −0.1%, more preferably less than about −0.2%, even more preferably less than about −0.3%, and most preferably less than about −0.4%.

As described above, the outer glass cladding portion 106 has a relative refractive index Δ_{OC}%>Δ_{M}%. Accordingly, it should be understood that the outer glass cladding portion 106 may comprise pure silica glass, silica glass up-doped with one or more dopants which increase the index of refraction of the outer glass cladding portion 106 with respect to pure silica glass, or silica glass down-doped with one or more dopants which decrease the index of refraction of the outer glass cladding portion 106 with respect to pure silica glass so long as Δ_{OC}%>Δ_{M}%.

It should be understood that the phrase “pure silica glass,” means that the silica glass does not contain material, such as dopants and/or other trace materials, in an amount which would significantly alter the refractive index of the silica glass. However, small amounts of dopants (e.g., chlorine and/or fluorine in an amount less than 1500 ppm of each) may be present in the silica glass which is otherwise pure silica.

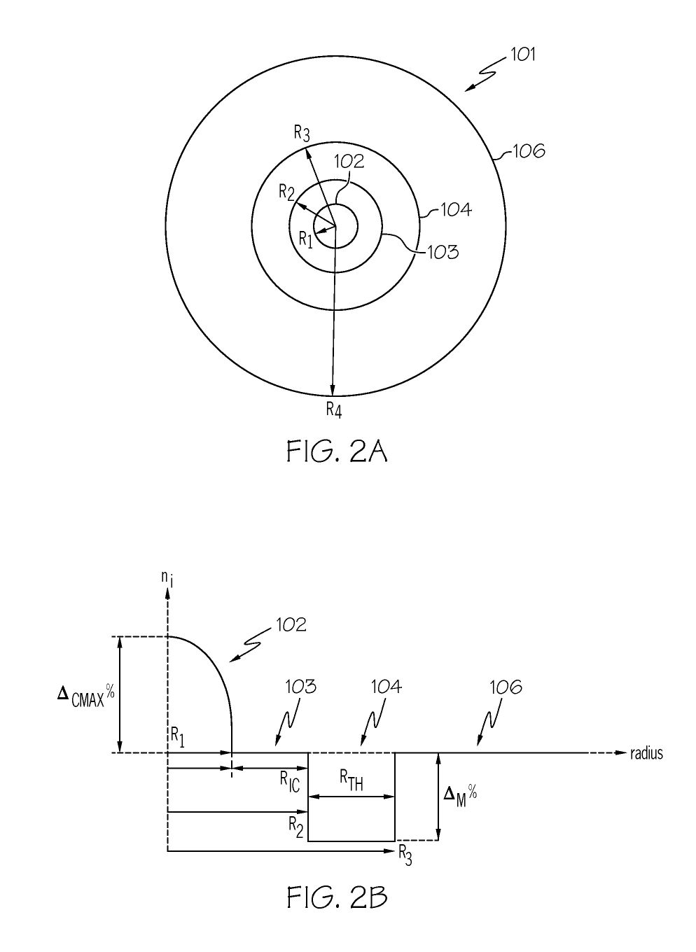

Referring to FIGS. 2A and 2B, another embodiment of preform 101 is depicted from which multimode, bend-loss resistant optical fiber may be drawn. In this embodiment, the moat portion 104 of the preform 101 may be spaced apart from the core portion 102 with an inner glass cladding portion 103. In this embodiment the inner glass cladding portion 103 may surround the core portion 102 and extend from the radius R₁ to the radius R₂ such that the inner glass cladding portion 103 has a radial thickness R_{IC}=R₂−R₁. In this embodiment, the moat portion 104 surrounds the inner glass cladding portion 103 and extends from the radius R₂ to the radius R₃ such that the moat portion 104 has a radial thickness R_{M}=R₃−R₂. The outer glass cladding portion 106 may surround the moat portion 104 and extend from the radius R₃ to the radius R₄. Accordingly, the glass portion of the optical fiber (e.g., the core portion 102, inner glass cladding portion 103, the moat portion 104 and the outer glass cladding portion 106) may have an outer diameter 2R₄.

In this embodiment, the core portion 102 may have an index of refraction n_{C} and a corresponding relative refractive index Δ_{C}% relative to pure silica glass, the inner glass cladding portion 103 may have an index of refraction n_{IC} and a corresponding relative refractive index Δ_{IC}% relative to pure silica glass and the moat portion 104 may have an index of refraction n_{M} and a corresponding relative refractive index Δ_{M}% relative to pure silica glass such that n_{C}>n_{IC}>n_{M} and Δ_{C}%>Δ_{IC}%>Δ_{M}% which corresponds to the refractive index profile generally shown in FIG. 2B. The core portion 102 may have a graded index of refraction profile between the center of the core portion 102 and the radius R₁ as described above. The outer glass cladding portion 106 may comprise an index of refraction n_{OC} and a relative refractive index Δ_{OC}% relative to pure silica glass which is generally greater than the relative refractive index Δ_{M}% of the moat portion 104 (e.g., Δ_{OC}%>Δ_{M}%) such that the moat portion 104 is a depressed index trench disposed between the inner glass cladding portion 103 and the outer glass cladding portion 106. The relative refractive index Δ_{OC}% of the outer glass cladding portion 106 may be greater than the relative refractive index Δ_{IC}% of the inner glass cladding portion 103, less than the relative refractive index Δ_{IC}% of the inner glass cladding portion or equal to the relative refractive index Δ_{IC}% of the inner glass cladding portion. Where the relative refractive index Δ_{OC}% of the outer glass cladding portion 106 is equal to the relative refractive index Δ_{IC}% of the inner glass cladding portion the composition of the outer glass cladding portion may be the same as the composition of the inner glass cladding portion 103.

The core portion 102, moat portion 104 and outer glass cladding portion 106 may have relative refractive indices similar to those described above with respect to the embodiment of the preform 100 shown in FIG. 1A. The inner glass cladding portion 103 may comprise pure silica glass, silica glass up-doped with one or more dopants which increase the index of refraction of the inner glass cladding portion 103 with respect to pure silica glass, or silica glass down-doped with one or more dopants which decrease the index of refraction of the inner glass cladding portion 103 with respect to pure silica glass so long as n_{C}>n_{IC}>n_{M}. For example, when the core portion 102 is up-doped and the moat portion 104 is down-doped, the inner glass cladding portion 103 may comprise pure silica glass such that n_{C}>n_{IC}>n_{M}. However, it should be understood that the core portion, 102 inner glass cladding portion 103 and moat portion 104 may have various other compositions which satisfy the relationship n_{C}>n_{IC}>n_{M}.

A multimode, bend-loss resistant optical fiber drawn from the preform 100 shown in FIG. 1A may have a core corresponding to the core portion 102, a depressed-index annular portion corresponding to the moat portion 104 and an outer cladding corresponding to the outer glass cladding portion 106. It should be understood that the various portions of the preform may be appropriately dimensioned such that, when an optical fiber is drawn from the preform, the optical fiber has the desired cross sectional dimensions. In general, the core of the optical fiber drawn from the preform will have a radius from about 22.5 microns to about 45 microns. For example, in one embodiment, the various portions of the preform 100 may be dimensioned such that an optical fiber drawn from the preform 100 has a core with a radius from at least about 22.5 microns to about 28 microns, more preferably from about 23 microns to about 27 microns and, even more preferably from about 23.5 microns to about 26.5 microns; a depressed-index annular portion having a radial thickness r_{TH} greater than about 0.5 microns to less than about 10 microns, more preferably greater than about 1.0 microns and less than about 8 microns, and, even more preferably, greater than about 2 microns and less than about 6 microns; and an outer cladding having a radial thickness such that the diameter of the optical fiber is about 125 microns.

Similarly, a multimode, bend-loss resistant optical fiber drawn from the preform 101 shown in FIG. 2A may have a core corresponding to the core portion 102, an inner cladding corresponding to the inner glass cladding portion 103, a depressed-index annular portion corresponding to the moat portion 104 and an outer cladding corresponding to the outer glass cladding portion 106. The various portions of the preform may be appropriately dimensioned such that, when an optical fiber is drawn from the preform, the optical fiber has the desired cross sectional dimensions. In general, the core of the optical fiber drawn from the preform will have a radius from about 22.5 microns to about 45 microns. For example, the various portions of the preform 101 may be dimensioned such that an optical fiber drawn from the preform has a core having a radius from at least about 22.5 microns to about 28 microns, more preferably from about 23 microns to about 27 microns and, even more preferably from about 23.5 microns to about 26.5 microns; an inner cladding having a radial thickness r_{IC} from about 0.5 microns to about 4 microns, more preferably greater than about 0.5 micron and less than 3 microns and, most preferably, greater than about 0.5 microns and less than about 2.0 microns; a depressed-index annular portion having a radial thickness r_{TH} from about 0.5 microns to about 10 microns, more preferably greater than about 1.0 microns and less than 8 microns, and even more preferably greater than 2 microns and less than 6 microns; and an outer cladding having a radial thickness such that the diameter of the optical fiber is about 125 microns.

After a preform with a structure appropriate for forming multimode, bend-loss resistant optical fiber has been selected, refractive index profiles for the core portion and the moat portion of the preform are determined using the measurement techniques referenced hereinabove. In one embodiment, the refractive index profiles are determined by direct measurement. For example, in one embodiment, a refractive index profile for the core portion of the preform may be determined after the core portion of the preform is formed and before the moat portion is formed around the core portion. A refractive index profile may thereafter be determined for the moat portion of the preform after the moat portion is formed around the core portion. Alternatively, refractive index profiles for both the core portion and the moat portion may be determined after the moat portion is formed around the core portion.

FIGS. 1B and 2B depict refractive index profiles for the preform constructed from individual refractive index profiles for the various portions of the preform. For example, FIGS. 1B and 2B generally indicate that the core refractive index profile of the core portion 102 of the preform has a graded, substantially parabolic refractive index profile which extends from the center of the core portion 102 to the radius R₁ of the core portion. The core refractive index profile is non-negative, as indicated in FIGS. 1B and 2B.

Further, FIGS. 1B and 2B indicate that the moat refractive index profile of the moat portion 104 of the preform generally has a step index profile which, in the embodiment shown in FIG. 1B, extends between the inner radius of the moat portion (i.e., the radius R₁) and the outer radius of the moat portion (i.e., radius R₂). Between R₁ and R₂ the index of refraction of the moat portion is negative having an index of refraction which is less than pure silica glass. Alternatively, in the embodiment shown in FIG. 2B, the step index profile of the moat portion extends between the inner radius of the moat portion 104 (i.e., radius R₂) and the outer radius of the moat portion (i.e., radius R₃). Between R₂ and R₃ the index of refraction of the moat portion is negative having an index of refraction which is less than pure silica glass.

After refractive index profiles for the core portion 102 and the moat portion 104 of the preform are determined, the refractive index profiles may be used in conjunction with the desired dimensions of a multimode bend-loss resistant optical fiber to be drawn from the preform and fiber property coefficients to determine one or more properties of the multimode bend-loss resistant optical fiber prior to drawing the optical fiber from the preform.

For example, in one embodiment, the fiber property coefficients are bend-loss coefficients and the core refractive index profile of the preform, the moat refractive index profile of the preform, the inner radius rᵢₙ and outer radius rₒᵤₜ of the depressed-index annular portion of the multimode optical fiber are used in conjunction with the bend-loss coefficients to determine a bend-loss of a multimode optical fiber before the multimode optical fiber is drawn from the preform. In this embodiment, the bend-loss of the optical fiber is determined with the equation:

BL=A_{BL}+B_{BL}·exp(C_{BL}·V)−D_{BL}Δ_{C}%−E_{BL}·d_{C} (1),

where BL is the bend-loss in dB/turn, A_{BL}, B_{BL}, C_{BL}, D_{BL}, and E_{BL} are bend-loss coefficients, d_{c} is the desired diameter of a core of the multimode optical fiber, V is the volume profile of the depressed-index annular portion of the multimode optical fiber, and Δ_{CMax}% is the maximum relative refractive index of the core portion of the preform.

As described hereinabove, the desired diameter d_{C} of the core of the multimode optical fiber may be from about 45 microns to about 56 microns, preferably from about 47 microns to about 53 microns.

The volume profile V of the depressed-index annular portion of the multimode optical fiber may be calculated according to the equation:

$$V = 2 {\int }_{{r}_{in}}^{{r}_{out}} {Δ}_{M} \% ( r ) \cdot r \cdot d r , \qquad ( 2 )$$

where Δ_{M}% is the relative refractive index of the moat portion of the preform, rᵢₙ is the inner radius of the depressed-index annular portion of the multimode optical fiber and rₒᵤₜ is the outer radius of the depressed-index annular portion of the multimode optical fiber such that the radial thickness of the depressed-index annular portion is rₜₕ=rₒᵤₜ−rᵢₙ. Where the multimode optical fiber is drawn from a preform having a cross section as shown in FIG. 1A, the inner radius of the depressed-index annular portion of the multimode optical fiber corresponds to the radius of the core of the multimode optical fiber which, in the embodiments described herein, has a value from about 22.5 microns to about 26.5 microns. Where the radial thickness of the depressed-index annular portion of the multimode optical fiber is from about 0.5 microns to about 10 microns, as described herein, the outer radius of the depressed-index annular portion may be from about 23 microns to about 36.5 microns.

Alternatively, where the multimode optical fiber is drawn from a preform having a cross section as shown in FIG. 2A, the inner radius of the depressed-index annular portion of the optical fiber corresponds to the outer radius of the inner cladding portion. Accordingly, the inner radius of the depressed-index annular portion may be from about 23.0 microns to about 30.5 microns. Where the radial thickness of the depressed-index annular portion of the optical fiber is from about 0.5 microns to about 10 microns, as described above, the outer radius of the depress-index annular portion may be from about 23.5 microns to about 40.5 microns.

The relative refractive index Δ_{M}%(r) of the moat portion of the preform may be calculated according to the equation:

Δ_{M}%(r)=100·(n_{M}(r)²−n_{REF}²)/2n_{M}(r)² (3),

where n_{M}(r) is the index of refraction in the moat portion of the optical fiber preform at a radius r as determined from the moat refractive index profile of the preform.

The maximum relative refractive index Δ_{CMax}% of the core portion of the preform may be calculated according to the equation:

Δ_{CMax}%=100·(n_{CMax}²−n_{REF}²)/2n_{CMax}² (4),

where n_{CMax} is the maximum index of refraction in the core portion of the optical fiber preform as determined from the core refractive index profile of the preform.

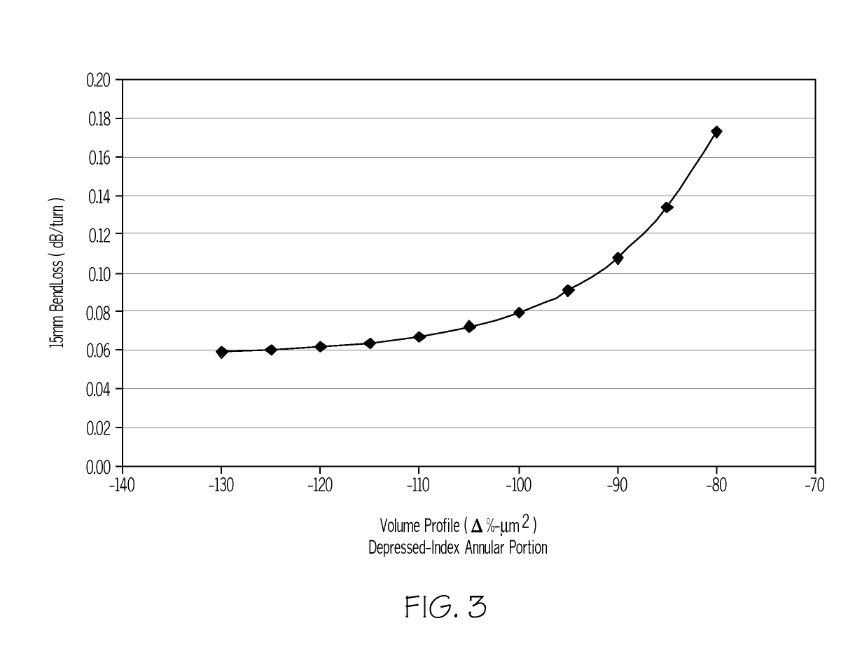

Referring to FIG. 3, in one embodiment, the bend-loss coefficients A_{BL}, B_{BL}, C_{BL}, D_{BL}, and E_{BL} are determined empirically by measuring the bend losses for a plurality of multimode optical fibers with depressed-index annular portions having known volume profiles V and plotting the measured bend losses as a function of the volume profile as shown in FIG. 3 which depicts the 15 mm bend-loss for multimode optical fibers as a function of the volume profile of the depress-index annular portion of the multimode optical fiber. The bend-loss measurements may be performed using the protocol for bend-loss measurements referred to hereinabove. As shown in FIG. 3, as the profile volume of the depressed-index annular portion becomes less negative, the bend-loss of the optical fiber increases.

After the bend losses are plotted as a function of the volume profile, a line may be fit through the resulting curve yielding a relationship between the volume profile and the bend-loss. The bend-loss coefficients A_{BL}, B_{BL}, C_{BL}, D_{BL}, and E_{BL} were determined through this curve fitting process. For a 15 mm bend diameter at a wavelength the 850 nm the bend-loss coefficient A_{BL} may generally be greater than 0 and less than 10; the bend-loss coefficient B_{BL} may be greater than 10 and less than 1000; the bend-loss coefficient C_{BL} may be greater than 0 and less than 1; the bend-loss coefficient D_{BL} may be greater than 0 and less than 10; and the bend-loss coefficient E_{BL} may be greater than 0 and less than 1. For a 30 mm bend diameter at a wavelength the 850 nm the bend-loss coefficient A_{BL} may generally be greater than 0 and less than 10; the bend loss coefficient B_{BL} may be greater than 10 and less than 1000; the bend-loss coefficient C_{BL} may be greater than 0 and less than 2; the bend loss coefficient D_{BL} may be greater than 0 and less than 10; and the bend-loss coefficient E_{BL} may be greater than 0 and less than 1. Table 1, shown below, contains exemplary values for the bend-loss coefficients for 15 mm and 30 mm diameter bend conditions. Both the 15 mm and 30 mm of bend-loss coefficients were determined at 850 nm. Further, while Equation (1) indicates an exponential relationship between the depressed-index annular portion volume profile and the bend-loss, it should be understood that a linear relationship between the depressed-index annular portion volume profile and the bend-loss may also be established through appropriate curve fitting techniques with corresponding linear bend-loss coefficients. Accordingly, is should be understood that other equations relating the volume profile of the depressed-index annular portion to bend-loss and the corresponding bend-loss coefficients may be used in conjunction with the methods described herein.

TABLE 1
Empirically Determined Bend Loss Coefficients

| Bend Dia. | A_{BL} | B_{BL} | C_{BL} | D_{BL} | E_{BL} |
|---|---|---|---|---|---|
| 15 mm | 0.855841 | 87.824443 | 0.082927 | 0.396567 | 0.008560 |
| 30 mm | 0.457635 | 87.824143 | 0.101200 | 0.319266 | 0.002828 |

Accordingly, it should now be understood that Equation (1) may be used to predict the bend-losses for a multimode optical fiber of specified dimensions before the fiber is drawn from a preform having a specific core refractive index profile and a specific moat refractive index profile. In this manner, the suitability of the preform for forming multimode optical fiber with the desired bend-loss properties may be evaluated prior to drawing the multimode fiber from the preform.

For example, the multimode optical fibers may have a 15 mm target bend-loss range at 850 nm of less than 0.2 dB/turn, more preferably less than 0.1 dB/turn and, even more preferably, less than 0.05 dB/turn. Equation (1) and the coefficients of Table 1 may be used in conjunction with the desired dimensions of the optical fiber, the core refractive index profile of the preform and the moat refractive index profile of the preform to determine if the preform is suitable for drawing multimode optical fiber having bend-loss properties within the target bend-loss range. If the bend-loss BL for the desired optical fiber, as determined with Equation (1), is within the target bend-loss range, the preform is suitable for forming multimode optical fiber with the desired bend-loss properties and, thereafter, multimode fiber may be drawn from the optical fiber preform. However, if the bend-loss BL, as determined from Equation (1), is not within the target bend-loss range, the preform is not suitable for forming multimode optical fiber with the desired bend-loss properties and the multimode optical fiber is not drawn from the preform.

Alternatively, the multimode optical fibers may have a 30 mm target bend-loss range at 850 nm of less than 0.2 dB/turn, more preferably less than 0.1 dB/turn and, even more preferably, less than 0.05 dB/turn. Accordingly, if the bend-loss BL for the desired optical fiber, as determined with Equation (1) and the appropriate coefficients from Table 1, is within the target bend-loss range the preform is suitable for forming multimode optical fiber with the desired bend-loss properties and, thereafter, multimode fiber may be drawn from the optical fiber preform.

In another embodiment, the fiber property coefficients are numerical aperture coefficients and the core refractive index profile of the preform, the moat refractive index profile of the preform, the inner radius rᵢₙ and outer radius rₒᵤₜ of the depressed-index annular portion of the multimode optical fiber are used in conjunction with the numerical aperture coefficients to determine a numerical aperture of a multimode optical fiber before the multimode optical fiber is drawn from the preform. In this embodiment, the numerical aperture of the multimode optical fiber is determined with the equation:

NA=NA_{C}−A_{NA}V−B_{NA} (5),

where NA_{C} is the numerical aperture of the core, V is the volume profile of the depressed-index annular portion of the optical fiber as defined in Equation (2) above, and A_{NA} and B_{NA} are the numerical aperture coefficients.

The numerical aperture of the core may be expressed mathematically as:

$${NA}_{C} = {n}_{REF} \sqrt{\frac{2 \frac{{Δ}_{C} \%}{100}}{1 - 2 \frac{{Δ}_{C} \%}{100}}} , \qquad ( 6 )$$

where n_{REF} is the index of refraction of pure silica glass. In the embodiments described herein, n_{REF} is the index of refraction of pure silica glass at 850 nm which is 1.4524982. Δ_{C}% is the relative refractive index of the core portion of the preform as defined in Equation (4) and described above.

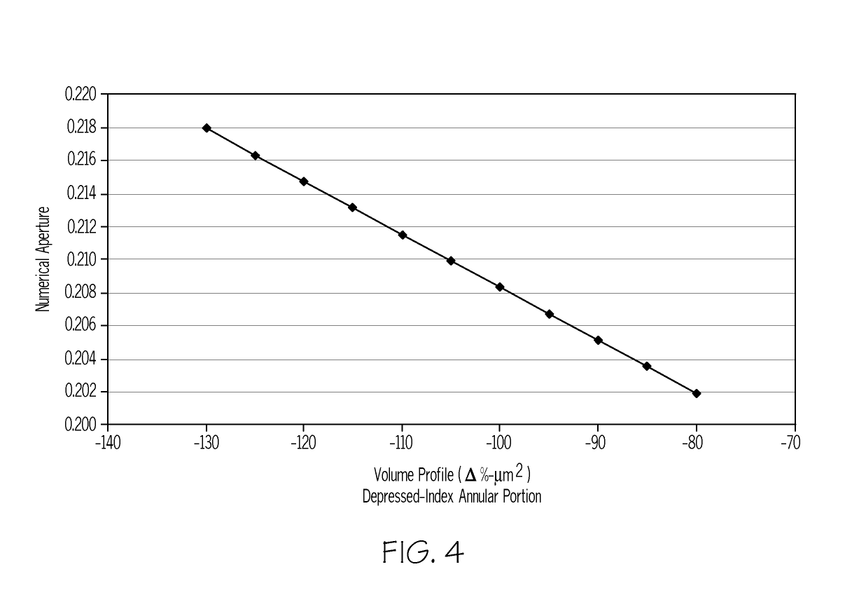

Referring to FIG. 4, in one embodiment, the numerical aperture coefficients A_{NA} and B_{NA} are determined empirically by measuring the numerical aperture for a plurality of multimode optical fibers with depressed-index annular portions having known volume profiles V at a wavelength of 850 nm The numerical aperture measurements may be performed using the protocol for numerical aperture measurement referred to hereinabove. The measured values of numerical aperture are plotted as a function of volume profile of the depressed-index annular portion as shown in FIG. 4. As shown in FIG. 4, as the volume profile of the depressed-index annular portion becomes less negative, the numerical aperture of the multimode optical fiber decreases.

After the measured numerical aperture values are plotted as a function of the volume profile, a line may be fit through the resulting curve yielding a relationship between volume profile and numerical aperture. At a wavelength of 850 nm the numerical aperture coefficient A_{NA} may be greater than 0 and less than 1 while the numerical aperture coefficient B_{NA} may be greater than 0 and less than 1. For example, in one embodiment, the numerical aperture coefficients A_{NA} and B_{NA} were determined through this curve fitting process to be 0.000296474 and 0.022110436, respectively.

Equation (5) may be utilized to predict the numerical aperture of a multimode optical fiber of specified dimensions before the multimode optical fiber is drawn from a preform having a specific core refractive index profile and a specific moat refractive index profile. In this manner, the suitability of the preform for forming multimode optical fiber with the desired numerical aperture may be evaluated prior to drawing the multimode fiber from the preform.

For example, the multimode optical fibers described herein may have a target numerical aperture range from 0.17 to about 0.23, more preferably greater than 0.18 and, most preferably from about 0.185 to about 0.215. Equation (5) may be used in conjunction with the desired dimensions of the multimode optical fiber, the core refractive index profile of the preform and the moat refractive index profile of the preform to determine if the preform is suitable for drawing multimode optical fiber having a numerical aperture within the target range. If the numerical aperture NA for the desired optical fiber, as determined with Equation (5), is within the target range, the preform is suitable for forming multimode optical fiber with the desired numerical aperture and, thereafter, multimode fiber may be drawn from the optical fiber preform. However, if the numerical aperture NA, as determined from Equation (5), is not within the target range, the preform is not suitable for forming multimode optical fiber with the desired numerical aperture and the multimode optical fiber is not drawn from the preform.

In the embodiments described herein either the bend-loss or the numerical aperture of multimode optical fiber are determined from the desired dimensions of the optical fiber, the core refractive index profile of the preform and the moat refractive index profile of the preform prior to the fiber being drawn from the preform. However, it should be understood that, in other embodiments, both the bend-loss and the numerical aperture may be determined from the desired dimensions of the optical fiber, the core refractive index profile of the preform and the moat refractive index profile of the preform and the multimode optical fiber is drawn from the optical fiber preform when the determined values for the bend-loss and numerical aperture are within the respective target ranges.

It should also be understood that the methods described herein may be used to characterize the properties of a multimode optical fiber before the fiber is drawn from a preform. This methodology may be used to verify that the preform is suitable for producing an optical fiber having the desired properties before the optical fiber is actually drawn from the preform. The methodologies described herein may be used to improve fiber quality and reduce manufacturing costs and waste. For example, suitable preforms may be selected based on their physical characteristics without having to draw and measure fiber to determine the suitability of the preform for forming optical fiber with the desired characteristics thereby avoiding product waste and lost manufacturing time. Further, the methods described herein may be used to improve the quality of the optical fiber produced as non-conforming preforms can be identified early in the manufacturing process and discarded or otherwise disposed of thereby insuring that only optical fiber with the desired characteristics are produced.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for characterizing a multimode, bend resistant optical fiber comprising:
determining a core refractive index profile for a core portion of a preform;
determining a moat refractive index profile for a moat portion of the preform; and
determining a property of a multimode optical fiber if the multimode optical fiber were drawn from the preform based on the core refractive index profile of the preform, the moat refractive index profile of the preform, an inner radius rᵢₙ and an outer radius rₒᵤₜ of a depressed-index annular portion of the multimode optical fiber and fiber property coefficients.

2. The method of claim 1 wherein the property is a bend-loss of the multimode optical fiber and the fiber property coefficients are bend-loss coefficients.

3. The method of claim 2 wherein the bend-loss is determined by:
determining a moat relative refractive index Δ_{M}%(r) for the moat portion of the preform based on the moat refractive index profile for the moat portion of the preform;
determining a maximum core relative refractive index Δ_{CMax}% for the core portion of the preform based on a maximum index of refraction n_{CMax} of the core portion of the preform; and
determining the bend-loss according to the equation:
BL=A_{BL}+B_{BL}·exp(C_{BL}·V)−D_{BL}·Δ_{C}%−E_{BL}·d_{C}
wherein:
d_{C} is a diameter of a core of the multimode optical fiber;
$$V = 2 {\int }_{{r}_{in}}^{{r}_{out}} {Δ}_{M} \% ( r ) \cdot r \cdot d r ;$$
and
A_{BL}, B_{BL}, C_{BL}, D_{BL}, and E_{BL} are the bend-loss coefficients.

4. The method of claim 3 wherein the bend-loss is determined for a bend diameter of 15 mm at a wavelength of 850 nm, wherein:
A_{BL} is greater than 0 and less than 10;
B_{BL} is greater than 10 and less than 1000;
C_{BL} is greater than 0 and less than 1;
D_{BL} is greater than 0 and less than 10; and
E_{BL}=is greater than 0 and less than 1.

5. The method of claim 3 wherein the bend-loss is determined for a bend diameter of 30 mm at a wavelength of 850 nm, wherein:
A_{BL} is greater than 0 and less than 10;
B_{BL} is greater than 10 and less than 1000;
C_{BL} is greater than 0 and less than 2;
D_{BL} is greater than 0 and less than 10; and
E_{BL}=is greater than 0 and less than 1.

6. The method of claim 2 further comprising drawing the multimode optical fiber from the preform when the bend-loss is less than about 0.2 dB/turn for a 15 mm bend diameter at a wavelength of 850 nm

7. The method of claim 2 further comprising drawing the multimode optical fiber from the preform when the bend-loss is less than about 0.2 dB/turn for a 30 mm bend diameter at a wavelength of 850 nm

8. The method of claim 1 wherein the property is a numerical aperture of the multimode optical fiber and the fiber property coefficients are numerical aperture coefficients.

9. The method of claim 8 wherein the numerical aperture of the multimode optical fiber is determined by:
determining a moat relative refractive index Δ_{M}%(r) for the moat portion of the preform based on moat refractive index profile of the moat portion of the preform;
determining a maximum core relative refractive index Δ_{CMax}% for the core portion of the preform based on a maximum index of refraction n_{CMax} of the core portion of the preform; and
determining the numerical aperture of the multimode optical fiber according to the equation:
NA=NA_{C}−A_{NA}V−B_{NA},
wherein:
$${NA}_{C} = {n}_{REF} \sqrt{\frac{2 \frac{{Δ}_{C} \%}{100}}{1 - 2 \frac{{Δ}_{C} \%}{100}}} ; V = 2 {\int }_{{r}_{in}}^{{r}_{out}} {Δ}_{M} \% ( r ) \cdot r \cdot d r ;$$
and
A_{NA} and B_{NA} are numerical aperture coefficients.

10. The method of claim 9 wherein the numerical aperture is determined at a wavelength of 850 nm, A_{NA} is greater than 0 and less than 1 and B_{NA} is greater than 0 and less than 1.

11. The method of claim 8 further comprising:
comparing the numerical aperture to a target numerical aperture range; and
drawing the multimode optical fiber from the preform when the numerical aperture is within the target numerical aperture range.

12. The method of claim 11 wherein the target numerical aperture range is from about 0.17 to about 0.23.

13. The method of claim 1 wherein the multimode optical fiber comprises:
a core having a radius from about 22.5 microns to about 45 microns with an index of refraction n_{C} corresponding to the core portion of the preform; and
the depressed-index annular portion surrounds the core and has a radial thickness from about 0.5 microns to about 10 microns and an index of refraction n_{M} corresponding to the moat portion of the preform, wherein n_{M}<n_{C}.

14. The method of claim 13 wherein the depressed-index annular portion is spaced apart from the core with an inner cladding having a radius from about 0.5 microns to about 4 microns and an index of refraction n_{IC} corresponding to an inner glass cladding portion of the preform, wherein n_{M}<n_{IC}<n_{C}.

15. The method of claim 13 wherein the index of refraction of the core of the multimode optical fiber is graded in a radial direction from a center of the core.

16. A method of drawing a multimode optical fiber from a preform comprising:
determining a core refractive index profile of a core portion of a preform;
determining a moat refractive index profile of a moat portion of the preform;
determining a bend-loss of a multimode optical fiber if the multimode optical fiber were drawn from the preform based on the core refractive index profile of the core portion of the preform, the moat refractive index profile of the moat portion of the preform, an inner radius rᵢₙ and an outer radius rₒᵤₜ of a depressed-index annular portion of the multimode optical fiber and bend-loss coefficients;
comparing the bend-loss to a target bend-loss range; and
drawing the multimode optical fiber from the preform when the bend-loss is within the target bend-loss range.

17. The method of claim 16 wherein the target bend-loss range is less than about 0.2 dB/turn for a 15 mm bend diameter at a wavelength of 850 nm

18. The method of claim 16 wherein the target bend-loss range is less than about 0.2 dB/turn for a 30 mm bend diameter at a wavelength of 850 nm

19. The method of claim 16 further comprising:
determining a numerical aperture of the multimode optical fiber if the multimode optical fiber were drawn from the preform based on the core refractive index profile of the core portion of the preform, the moat refractive index profile of the moat portion of the preform, the inner radius rᵢₙ and the outer radius rₒᵤₜ of the depressed-index annular portion of the multimode optical fiber and numerical aperture coefficients;
comparing the numerical aperture to a target numerical aperture range;
drawing the multimode optical fiber from the preform when the bend-loss is within the target bend-loss range and the numerical aperture is within the target numerical aperture range.

20. The method of claim 19 wherein:
the target bend-loss range is less than about 0.2 dB/turn for a 15 mm bend diameter at a wavelength of 850 nm; and
the target numerical aperture range is from about 0.17 to about 0.23.
